(19) United States
(12) Patent Application Publication
(10) Pub. No.: US 2006/0022648 A1
(43) Pub. Date: Feb. 2, 2006

(54) Method and control circuitry for improved-performance switch-mode converters

(75) Inventors: Shmuel Ben-Yaakov, (US); Ilya Zeltser, (US)

Correspondence Address: PEARL COHEN ZEDEK, LLP, 10 ROCKEFELLER PLAZA, SUITE 1001, NEW YORK, NY, 10020, US

(73) Assignee: Green Power Technologies Ltd.

(21) Appl. No.: 11/193,495

(22) Filed: Aug. 1, 2005

Related U.S. Application Data
(60) Provisional application No. 60/592,377, filed on Aug. 2, 2004.

(51) Int. Cl. G05F 1/656

(52) U.S. Cl. 323/222

(57) ABSTRACT

A system and method for supplying power to a load and for controlling the power factor presented to the power line. Output voltage is controlled by a digital, outer, control loop, and inner, analog, control loop causes the input current to be substantially proportional to the input voltage at any particular point in the power line cycle. Thus, the system presents a load to the power line that appears to be purely resistive. The use of an analog multiplier is not required, nor is sampling of input voltage. Limiting of inrush current provides for brown-out protection and soft-start.

### RELATED APPLICATIONS

This application claims the benefit of earlier-filed provisional application Ser. No. 60/592,377, filed on Aug. 2, 2004 and entitled “Method and Controller Circuitry for Improved Performance Switch-Mode Converters”.

### FIELD AND BACKGROUND OF THE INVENTION

The present invention relates to the field of switching power converters. More particularly, the present invention relates to a method and circuitry for improving the input current and/or output voltage regulation of switching power converters.

Currently, there are several types of power converters which are widely used for DC-to-DC, DC-to-AC, AC-to-DC and AC-to-AC power conversion. In some applications the purpose of the converter is to provide a regulated output voltage. In other applications the purpose of the power conversion scheme is to shape the input current at the input terminals of the converter so that the input current will follow the shape of the input voltage. For example, in a power converter known in the art as an Active Power Factor Correction (APFC) converter, the role of the converter is to ensure that the current drawn from the AC power line is in phase with the line voltage with minimum high-order harmonics. A typical and well-known implementation of an APFC converter is illustrated in FIG. 1 (prior art). In FIG. 1, input voltage V_{ac} is rectified by diode bridge D₁ and fed to a “Boost” or “Step-up” converter that includes an input inductor Lᵢₙ, a transistor Q₁, a high frequency rectifier D₂, an output filter capacitor Cₒ and a load R_{L}. A power switch Q₁ is driven by a high frequency control signal having a duty-cycle D_{ON} so as to force an input current Iᵢₙₐ to follow the shape of rectified input voltage V_{inR}, in which case the power converter behaves essentially as a resistive load on the AC power line; i.e., the power factor (PF) is unity.

The growing use of APFC converters is driven by the concern for the quality of AC power line supplies. Injection of high harmonics into the power line, and poor power factor in general, are known to cause many problems. Among these are lower efficiency of power transmission, possible interference to other electrical units connected to the power line and distorted shape of the line voltage. In light of the practical importance of APFC converters, many countries have adopted, or are in the process of adopting, voluntary and mandatory standard and statutes, which set limits on the permissible current line harmonics injected by any given electrical equipment powered by the AC mains, in order to maintain relatively high power quality. Another advantage of an APFC converter is that it allows a better exploitation of the power that can drawn from a given AC power line. Without power factor correction, the current drawn from AC power line includes a relatively high level of unwanted harmonics, which may be greater than the magnitude of the first harmonic of the current, the latter being the only component that contributes real power to the load. The generally undesirable I²R heating of wiring and motor and transformer windings is proportional to the square of the rms value of the current, which includes contributions from all harmonics. Additionally, protection elements, such as fuses and circuit breakers, generally respond to the rms value of the current. Consequently, the rms value of the current limits the maximum power that can be drawn from the line. In equipment having power factor correction the rms current essentially equals the rms value of the first harmonic of the current (due to the suppression of higher harmonics) and, hence, the power that can be drawn from the line essentially reaches the maximum theoretical value. It is thus evident that the need for APFC circuits is widespread and that economical implementation of such circuits is of prime importance. Cost is of great concern considering the fact that the APFC is generally an additional expense not directly related to the basic functionality of the equipment in which the APFC converter is included.

Common APFC circuits generally operate in closed feedback configurations. For example, in the circuit illustrated in FIG. 1 (prior art) a power factor correction (PFC) controller CONT samples an input current Iᵢₙₐ and generates pulses D_{ON} in order to drive a power switch Q₁ such as to force a current Iᵢₙₐ in an inductor Lᵢₙ to follow the shape of a rectified input voltage V_{inR}. Input current Iᵢₙₐ is adjusted for any given load R_{L} by monitoring output of the voltage divider R₁, R₂ to form a low-voltage sense voltage V_{od} proportional to an output voltage V_{O}, comparing it to a desired value for V_{O} and applying a resulting error signal to adjust D_{ON}. Controller CONT could be based on analog circuitry.

In the circuit illustrated in FIG. 2 (prior art) a controller CONT_D is implemented as digital circuitry. In this system the shape of the rectified power line voltage V_{inR} is sampled by utilizing voltage V_{inR}, which is obtained from voltage divider Rₐ, R_{b}. In this case V_{inR} is used as the reference voltage for the desired shape of input current Iᵢₙₐ. Controller CONT_D also receives a voltage V_{Rs}, measured across a sense resistor Rₛ and proportional to input current Iᵢₙₐ. By applying a preprogrammed control algorithm, CONT_D generates pulses D_{ON} in order to drive power switch Q₁ such as to force inductor current Iᵢₙₐ to follow reference voltage shape V_{inR}. Current Iᵢₙₐ is adjusted for any given load R_{L} by monitoring output voltage Vₒ via voltage divider R₁, R₂ to generate a reference signal V_{od} that is applied in the algorithm of CONT_D to adjust D_{ON} so as to keep Vₒ close to a predetermined level.

A digitally implemented controller has numerous advantages compared to an analog controller, such as the ability to adjust and optimize the control functions by re-programming the controller, even after installation, the robustness and stability of digital circuitry, as compared to analog circuitry, the ease of including remote control and monitoring functions via a communication interface, and the utilization of sophisticated new circuitry resulting from the rapid advanceme of digital VLSI technology. Notwithstanding the many advantages of digital controllers, cost is still an obstacle that makes wide usage of this approach uneconomical in many applications. The main reason for the high cost is the requirement for a relatively wide-bandwidth control loop. In an APFC system two feedback loops are recognized: an “inner” current-control loop and an “outer” voltage-control loop. In the inner, current, loop the input current is sensed and the required control signal having an appropriate duty-cycle is generated according to a predetermined algorithm. The bandwidth of this current-control loop must be wide, corresponding to a short response time. This helps to quickly correct any deviation of the current from the required value. On the other hand, the voltage-control loop needs to be slow-responding because its function is to correct the parameters of the inner loop so that the target input current will correspond to the power drawn by the load. In fact, a fast-responding outer loop is considered harmful because it will cause undesired distortion of the input current due to modulation by the ac ripple of the output voltage. This phenomenon is well known to persons trained in the art and this is why the design of the outer loop generally specifies a narrow bandwidth.

The requirement for a wide bandwidth for the inner current-control loop implies that, in the case of a digital controller, the rate of sampling of the input current signal must be high. This implies that the analog-to-digital (A/D) converter of the digital controller (see FIG. 2) must include fast-responding circuitry of high accuracy in order to provide the required performance of the inner loop. The need for a wide-bandwidth inner loop is demonstrated in detail by considering an APFC control algorithm that does not require sensing of input voltage, as seen in U.S. Pat. No. 6,307,361, to Ben-Yaakov et al., “Method and Apparatus for Regulating the Input Impedance of PWM Converters” incorporated by reference for all purposes as if fully set forth herein.

In FIGS. 1 and 2, Vₐ (the voltage at node “a”) is a cyclic pulsating voltage having magnitude Vₒ during T_{OFF} when Q₁ is in a non-conductive state, and zero during T_{ON}, when Q₁ is in a conductive state. Consequently, the average value of Vₐ is:

$$〈 {V}_{a} 〉 = \frac{{V}_{O} {T}_{OFF}}{{T}_{S}} \qquad ( 1 )$$

wherein T_{S} is the Pulse Width Modulated (PWM) switching period, with T_{S}=T_{OFF}+T_{ON}, and the angle-brackets ( [symbol] ) imply an average value over a switching period.

Equivalently,

$$\begin{matrix}〈 {V}_{a} 〉 = {V}_{O} {D}_{OFF} wherein & ( 2 ) \\ {D}_{OFF} = \frac{{T}_{OFF}}{{T}_{S}} & ( 3 )\end{matrix}$$

Similarly, D_{ON} is defined as:

$${D}_{OFF} = \frac{{T}_{ON}}{{T}_{S}} \qquad ( 4 )$$

corresponding to when Q₁ is in a conductive state.

The average voltage across inductor Lᵢₙ is (V_{inR}- <Vₐ>) and the resulting average current <Iᵢₙₐ> will be:

$$〈 {I}_{ina} 〉 = \vert \frac{{V}_{inR} - 〈 {V}_{a} 〉}{j2 π {L}_{in} f} \vert \qquad ( 5 )$$

wherein f is the first harmonic component of the input current.

As has been shown in a number of publications (e.g., Ben-Yaakov, S. and Zeltser, I., “The dynamics of a PWM boost converter with resistive input.” IEEE Trans. Industrial Electronics, 46, pp. 613-619, 1999), the control law required to insure that the input terminal of the APFC will exhibit a resistive nature and be equivalent to a resistance Rₑ is:

$${D}_{off} = \frac{{R}_{e}}{{V}_{o}} 〈 {I}_{ina} 〉 \qquad ( 6 )$$

The block diagram of FIG. 3 illustrates the interaction between Equations (5) and (6). The closed-loop response of this system is given by:

$$\begin{matrix}\frac{{I}_{ina}}{{V}_{inR}} = \vert \frac{1}{{R}_{e}} \frac{1}{1 + \frac{j2 π f}{2 π {f}_{o}}} \vert wherein \text{:} & ( 7 ) \\ {f}_{O} = \frac{1}{2 π} \frac{{R}_{e}}{{L}_{in}} & ( 8 )\end{matrix}$$

Equation (8) implies that good tracking

$$( \frac{{I}_{ina}}{{V}_{inR}} ≅ \frac{1}{{R}_{e}} )$$

is obtained up to the break frequency fₒ, at which point the loop gain of the system approaches unity. This implies that for proper operation, the controller should be capable of processing signals up to the frequency fₒ. This is illustrated by considering, for example, a 1 kW APFC stage operating from a 220 Vac line and with Lᵢₙ=1 mH. In this case:

$${R}_{e} ( 1 kW ) = \frac{{220}^{2}}{{10}^{3}} = 48 Ω and {f}_{o} ( 1 kW ) = 7.6 kHz$$

However, if the load power drops, say, to 5% of its nominal value, we find:
fₒ(50 W)=153 kHz

It will be clear to those trained in the art that the required sampling rate for this case is at least 500 kHz to avoid instabilities or poor dynamic response due to low sampling rates and sampling delays.

In order for the inner, current-control loop to be sufficiently accurate, both the resolution of the A/D and that of the PWM circuitry of the digital controller of FIG. 2) need to be high. Because the resolution of the PWM signal of a digital controller is limited by the clock signal, the requirement for a high-resolution PWM signal implies that the digital controller must have a high clock frequency. For example, if the converter runs at a switching frequency of 100 kHz and the required resolution of the PWM signal is 1:1000 (10 bits resolution) then the required clock frequency will be 100 MHz.

In contrast to the strict requirements of the inner loop for a fast sampling rate, high accuracy of A/D conversion, and high clock frequency for generating a high-resolution PWM signal, the outer voltage loop can use a low sampling-rate A/D of relatively low accuracy. This is due to the fact, discussed above, that the required bandwidth for the outer loop is small. Typical values for bandwidth are 10 Hz (see again Ben-Yaakov, S. and Zeltser, I., “The dynamics of a PWM boost converter with resistive input.”). The resolution of the A/D needed for the outer loop is relatively low because, in most practical applications, the required accuracy of Vₒ is relaxed. This is possible because the APFC stage is normally followed by a DC-DC converter that controls the final output voltages of the system. Such a DC-DC converter is typically rather insensitive to variations in input voltage. Notwithstanding the relaxed requirements of the outer loop, it is the inner loop that sets the specification of the digital controller for an APFC per the prior art of FIG. 2. Consequently, in this prior art implementation, the required bandwidth for the inner, current-control loop, and the need for a high-resolution PWM signal dictate the selection of a digital controller with a very high clock frequency and a high-resolution, fast-sampling A/D. This significantly increases the cost of the digital solution as compared to the analog approach for APFC controllers.

Another engineering issue that needs to attention in the design of AC-DC converters is the control of the inrush current. That is, limiting the high current that will develop when power is applied to the system while bus capacitor Cₒ is discharged or at low voltage. Prior-art solutions to this problem fall into two categories. One approach is to insert a thermistor having a negative temperature coefficient in series with the input terminals. Because the resistance of the thermistor is large when the thermistor is cold, the thermistor will limit the inrush current. Once capacitor Cₒ has been charged and the thermistor has warmed up the resistance of the thermistor will decrease and the power dissipated in the thermistor will be reduced. Nonetheless, the thermistor will dissipate power even when warm, and therefore reduce the overall efficiency of the system. Furthermore the high steady-state temperature of the thermistor can reduce the reliability of the converter by introducing a hot spot. Another problem with the thermistor solution is that after a short brown-out period (reduction of line voltage) the inrush current resulting from restoration of full line voltage can be high because the thermistor may not have had enoughtime to cool down sufficiently during the brown-out.

A second approach to solving the inrush current problem is the introduction of an inrush-current control element activated by extra analog circuitry plus some logic circuitry operative to sense the instant of application of power to the system, as seen in U.S. Pat. No. 6,493,245 to Phadke, “Inrush Current Control for AC to DC Converters”, incorporated by reference for all purposes as if fully set forth herein. It is also desirable that the inrush-current control circuitry be capable of detecting a power-line brown-out so as to activate again the inrush current control element when full line voltage is restored. It is thus clear that the prior-art circuitry needs to be rather extensive, reducing the reliability, and increasing the manufacturing cost, of AC-DC converters.

In the foregoing discussion, emphasis has been placed on AC-DC converters with respect to the alternative methods for controlling such systems. However, the control issues illustrated above for APFC systems are also relevant to DC-DC switch-mode converters. In a typical prior-art converter, as illustrated schematically in FIG. 4, the objective of controller CONT is to stabilize output voltage Vo despite changes in load and input voltage. A typical DC-DC converter will include at least one switching element Q₁, an inductor Lᵢₙ, and an output capacitor Cₒ. For enhanced performance, both inductor current Iᵢₙₐ and output voltage Vo are sensed by controller CONT and used to generate the gate PWM gate pulse (Dₒₙ). The purpose of sensing the inductor current is to make the inductor behave as a current source and thus reduce the small-signal transfer function of the power stage to that of a first-order system. This decreases the phase delay of the system and therefore helps to achieve a fast feedback response. As is well known in the art, the current-control feedback loop needs to have a wide bandwidth as compared to the voltage-control feedback loop. Hence, as in the case of the APFC systems detailed above, a digital controller for a DC-DC converter will require a high clock frequency and a high sampling-rate A/D converter.

As in the cases of AC-DC and DC-DC converters, a digital controller for DC-AC inverters will suffer from similar drawbacks. It is thus clear that, notwithstanding the many potential advantages of a digital controller for power switch-mode systems, prior art implementations are complex and costly.

### SUMMARY OF THE INVENTION

There is thus a widely recognized need for, and it would be highly advantageous to have, controllers for switch-mode power systems that have the features of digital circuitry without the need for a high sampling-rate A/D and high-frequency clock. One, some or all of the below objectives may be realized in embodiments of the present invention.

It may be further desirable that a controller for an APFC system be able to be operated in an advanced manner in which there is no need to sample the input voltage, and be able to cope with the large bandwidths required by such a control scheme.

It is an objective of the present invention to provide circuitry for simplifying the construction, and increasing the reliability and flexibility, of controllers for switch-mode power systems.

It is another objective of the present invention to provide economical digital circuitry for improving the performance of switch mode controllers.

It is another objective of the present invention to eliminate the need for a high-resolution, high sampling-rate A/D and high-frequency clock presently associated with digital controllers for switch-mode power systems.

It is yet another objective of the present invention to provide controller circuitry that can integrate other functions, such as inrush current control and soft start, to simplify the construction, increase the reliability, and reduce the overall cost, of switch-mode converters.

Other objectives and advantages of the present invention will become apparent as the description proceeds.

### Definitions

As used herein, unless otherwise specified, the term “line” refers to an electric power line having at least two conductors. Such lines include DC power lines and AC power lines. DC power lines include, but are not limited to, power lines wherein one conductor, referred to herein as a “neutral” conductor, is substantially at ground potential. AC power lines include, but are not limited to, power lines wherein one conductor is substantially at ground potential, and is known as a “neutral” conductor, and wherein another conductor is at a varying potential and is known as a “phase” or “hot” conductor.

As used herein, unless otherwise specified, the term “duty-cycle” refers to the ratio of the time a pulse signal is in an on state to the total of the time the pulse signal is in the on state and the time the pulse signal is in a temporally adjacent off state.

As used herein, unless otherwise specified, the term “off-duty-cycle” refers to the ratio of the time a pulse signal is in an off state to the total of the time the pulse signal is in the off state and the time the pulse signal is in a temporally adjacent on state.

Aspects of embodiments of the present invention are directed to a method for controlling the operation of a switch-mode converter stage such that, in the case of an APFC, the input current will follow the input line voltage, thus appearing to the power line as a resistive load, and/or, in the case of a voltage regulator, to regulate the output voltage or, in the case of a DC-AC converter, to produce a desired voltage waveform at the output terminals of the converter. This may be accomplished according to the present invention by use of mixed-mode circuitry combining an analog portion and a digital portion. Accordingly, certain embodiments of the present invention may make optimal use of both analog technology and digital technology and eliminate the need for extremely high A/ID sampling rates and high-frequency clocks that increase the complexity and cost of purely digital controllers. Furthermore, the present invention also allows increasing the reliability of switch-mode converter systems by enabling the inclusion of additional functions such as inrush current control without adding considerable complexity and/or cost to the controller circuitry. A simplified diagram of a controller according to embodiments of the present invention is illustrated schematically in FIG. 5. The controller illustrated includes mixed-mode circuitry including an analog portion that is primarily for implementing an inner, current-control loop, and a digital portion that is for implementing an outer, voltage-control loop, carrying out logical decisions concerning delays following power failures or brown-outs, driving a Controlled Current Conducting Device (CCCD) used to control inrush current, and other functions that will become clear below.

Accordingly, embodiments of the present invention may be characterized by utilizing analog circuitry for fast control loops and digital control for slow control loops and supervisory circuitry.

Embodiments of the present invention may feature some or all of a switch-mode converter apparatus which has improved reliability, programmability features, and lower cost, compared to prior art, for switch-mode power converters, including at least an inductor, a controllable power switch connected in tandem with the inductor, and a mixed-mode controller.

In some embodiments of the invention, the switch mode converter may include some or all of:

a) voltage sampling circuitry, for sampling the instantaneous value of the output voltage level;

b) inductor-current sampling circuitry, for sampling the instantaneous value of the inductor current;

c) analog control circuitry fed by a signal proportional to the input current and which controls the timing of the switching of the controllable switch in response to input current so as to cause the waveshape of the input current to be essentially similar to the waveshape of the input voltage.

d) digital control circuitry fed by a signal proportional to the output voltage and which produces a control signal that affects the analog circuitry so as to adjust the input current level to the load and thereby stabilize the input current level and/or output voltage to desired values. The digital circuitry, which may be implemented as embedded firmware or as software running on a data processor such as a computer or microcontroller, can also, optionally, control the operation of the inrush circuitry and/or soft start of the power converter.

e) inrush current control circuitry operative to limit input current following power-on, operation of the inrush current control circuitry being controlled by the digital control circuitry.

Preferably, the switch-mode converter may further include:

f) input voltage sensing circuitry operative to sense the input voltage of the system.

g) logic-based circuitry or a program operative to utilize the sensed signals of input voltage, input current and output voltage to produce logic commands operative to shift the converter circuitry from one operational mode to another.

The analog control circuitry can, optionally, further include an amplifier operative to increase the signal level of the sensed input current, a comparator operative to compare the input current signal to a ramp voltage developing across a ramp capacitor, a controlled current source operative to charge the ramp capacitor, interface circuitry operative to interface the digital control circuitry with control terminals of the controlled current source, and a gate driver fed by the comparator and operative to drive the gate of the power switch.

The inrush current control circuitry can optionally further include a Controlled Current Conducting Device (CCCD) in series with inductor Lᵢₙ and controlled by the digital circuitry. During start-up the CCCD is set by the digital circuitry to limit the input current. After the main capacitor is charged the digital circuitry is operative to change the setting of the CCCD such that the CCCD will carry the full current with minimal voltage drop across the CCCD.

According to embodiments of the present invention there may be provided an active power factor correction power converter system comprising an analog control circuitry to control an input current of said system; a digital control circuitry to control an output voltage of said system; a current sampling device in the path of said input current to indicate an instantaneous value proportional to said input current being an input current indication, wherein said digital control circuitry is adapted to produce an analog signal responsive to variations in said output voltage, and wherein said analog control circuitry is responsive to said analog signal.

According to some embodiments of the present invention, there may be provided a method of controlling an input current and an output voltage in an active power factor correction power converter system comprising controlling an input current of said system by an analog control circuitry; controlling an output voltage of said system by a digital control circuitry; wherein said digital control circuitry is adapted to produce an analog signal responsive to variations in said output voltage, and wherein said analog control circuitry is responsive to said analog signal.

According to further embodiments of the present invention, there may be provided an active power factor correction power converter system comprising an analog control circuitry to control an input current of said system; a digital control circuitry to control an output voltage of said system; a current sampling device in the ground path of said input current to indicate an average of an instantaneous value proportional to said input current being an input current indication; a first voltage sampling branch to indicate an instantaneous value of said output voltage being an output voltage indication; a comparator unit responsive to a signal proportional to said input current indication and to a ramp-type signal driven by a controllable current source; a controllable current source to control the rise rate of said ramp-type signal to responsive to said output voltage indication; and a second voltage sampling branch to indicate an instantaneous value of a rectified input voltage of said system being an input voltage indication, wherein said digital control circuitry is adapted to produce an analog signal responsive to variations in said output voltage, wherein said analog control circuitry is responsive to said analog signal, wherein said digital control circuitry further comprises a digital controller comprising logic unit, a digitally controlled analog output, an analog-to-digital converter and an input/output unit.

According to further embodiments of the invention, there may be provided a method of controlling an input current and an output voltage in an active power factor correction power converter system comprising controlling an input current of said system by an analog control circuitry; controlling an output voltage of said system by a digital control circuitry, said digital control circuitry is adapted to produce an analog signal responsive to variations in said output voltage, receiving a signal proportional to an average of said input current being an input current indication; receiving a signal proportional to an instantaneous value of said output voltage being an output voltage indication comparing said signal proportional to said input current indication to a ramp-type signal; switching a current controllable shunt switch on whenever said signal proportional to said input current indication is bigger than said ramp-type signal and off when it is smaller than said ramp-type signal; controlling a rise rate of said ramp-type signal responsive to a deviation of said output voltage indication from a predetermined value; and controlling a maximum value of said input current by a controllable switching device in response to a signal from said digital control circuitry.

According to yet further embodiments of the present invention, there may be provided a power converter system comprising a rectifying circuitry to rectify an AC power to DC power; an analog control circuitry to control a current drawn from said rectifying circuitry; a digital control circuitry to control an output voltage of said system; a current sampling device in the ground path of said input current to indicate an average of an instantaneous value proportional to said input current being an input current indication; a first voltage sampling branch to indicate an instantaneous value of said output voltage being an output voltage indication; a comparator unit responsive to a signal proportional to said input current indication and to a ramp-type signal driven by a controllable current source; a controllable current source to control the rise rate of said ramp-type signal to responsive to said output voltage indication; and a second voltage sampling branch to indicate an instantaneous value of a rectified input voltage of said system being an input voltage indication, wherein said digital control circuitry is adapted to produce an analog signal responsive to variations in said output voltage, wherein said analog control circuitry is responsive to said analog signal, and wherein said digital control circuitry further comprises a digital controller comprising logic unit, a digitally controlled analog output, an analog-to-digital converter and an input/output-unit.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 (prior art) illustrates schematically an APFC boost converter based on an analog controller;

FIG. 2 (prior art) illustrates schematically an APFC boost converter based on a digital controller;

FIG. 3 (prior art) illustrates schematically, as a block diagram, a current-control loop of an APFC based on a controller which does not directly sense input voltage;

FIG. 4 (prior art) illustrates schematically two-loop control of a Buck converter;

FIG. 5 illustrates schematically a control scheme for a switch-mode converter according to the present invention;

FIG. 6 illustrates schematically an APFC stage according to a preferred embodiment of the present invention;

FIG. 7 illustrates schematically an APFC stage according to another embodiment of the present invention;

FIG. 8 illustrates schematically a possible series transistor connection for implementing the CCCD of the present invention;

FIG. 9 illustrates schematically a second possible series transistor connection for implementing the CCCD of the present invention;

FIG. 10 illustrates schematically a possible use of SCRs in implementing the CCCD of the present invention;

FIG. 11 illustrates schematically a buck converter stage according to an embodiment of the present invention;

FIG. 12 illustrates schematically a parallel connection of multiple APFC stages according to an embodiment of the present invention.

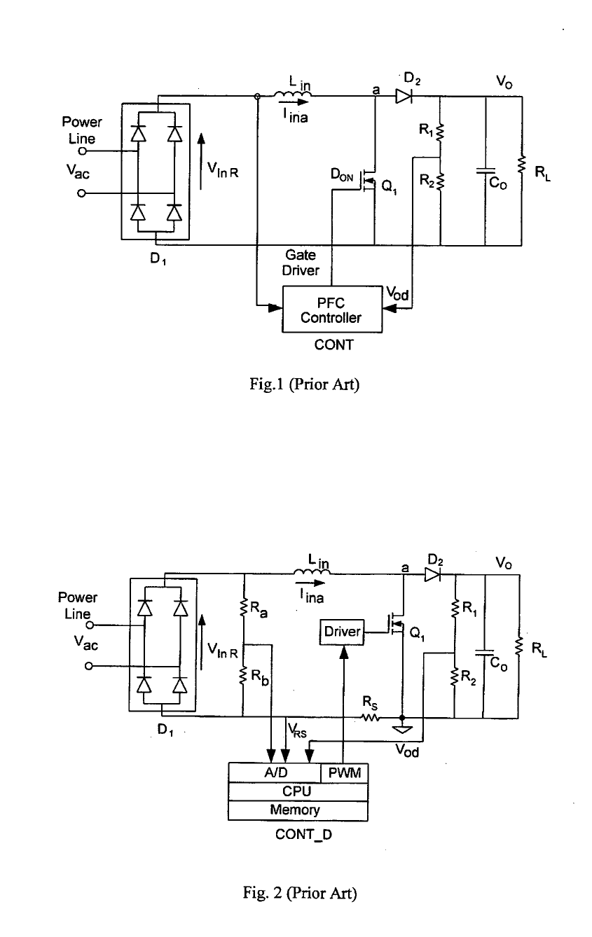

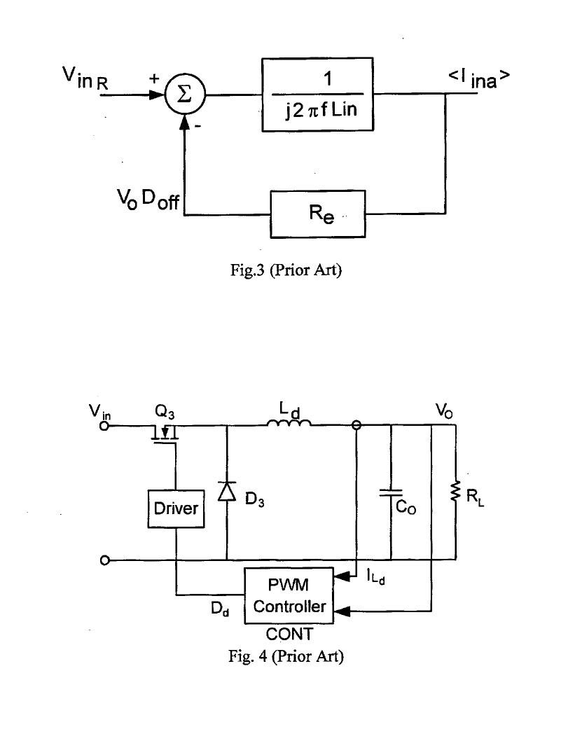

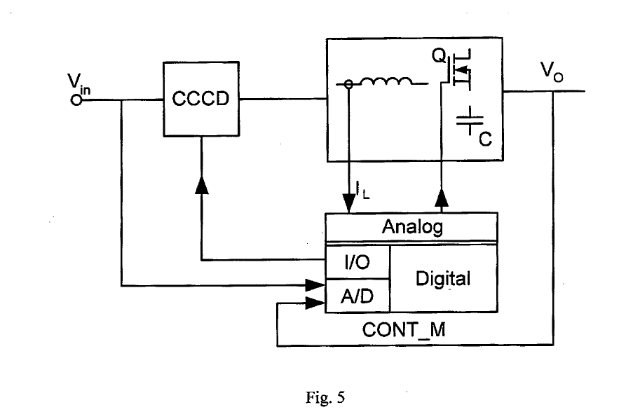

### DESCRIPTION OF THE PREFERRED EMBODIMENTS

The present invention is of a power converter which can provide a desired output voltage to a load while presenting the power line with a load having desired characteristics, such as, for example, unity power factor.

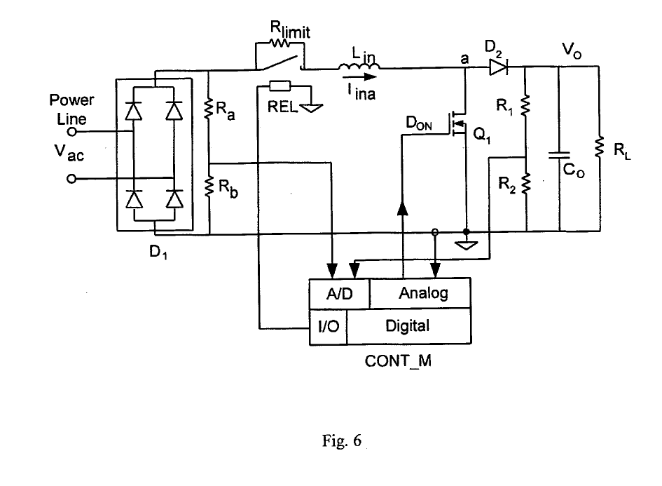

Referring now to the drawings, FIG. 6 illustrates a possible embodiment of an APFC stage according to the present invention. The power stage includes an inductor Lᵢₙ, a main switch Q₁, a main diode D₂, and an output capacitor Cₒ. The power stage also includes a relay REL having contacts connected in series with inductor Lᵢₙ. A charging resistor Rₗᵢₘᵢₜ is placed across the contacts of relay REL so that when those contacts are non-conducting current will flow will be limited by Rₗᵢₘᵢₜ. According to the present invention, a mixed mode controller CONT_M, having an analog section and a digital section, samples input voltage, input current Iᵢₙₐ, and output voltage Vₒ. The input current signal is processed according to a predetermined control algorithm by the analog section of CONT_M to produce pulses to be applied to the gate of Q₁. The digital section or CONT_M senses output voltages Vₒ and compares Vₒ to a desired, pre-programmed value, and produces a correction signal applied to the inner loop analog circuitry so as to adjust the input current to the load power at any given time. The digital section of CONT_M also senses the input voltage to detect the need for inrush current control. Before the system enters the normal state of operation the “normally open” contacts of inrush control relay REL are non-conducting and resistor Rₗᵢₘᵢₜ is thus in series with inductor Lᵢₙ. Consequently, during “power-on” bus capacitor Cₒ will charge via resistor Rₗᵢₘᵢₜ, thus limiting the inrush current. Further, during the charging of capacitor Cₒ the digital section of CONT_M disables the analog section of controller CONT_M such that main switch Q₁ will be kept in the “off” state. Once the digital section of CONT_M has sensed that capacitor Cₒ is sufficiently charged, and if input voltage is detected to be within a pre-determined allowable region, the digital section of CONT_M activates relay REL so as to effectively bypass Rₗᵢₘᵢₜ from the circuit. At the same time the digital section gradually reduces the disabling command to the analog section of CONT_M such that the duty-cycle D_{ON} of Q₁ will be allowed to increase, in accordance with the method known in the art as “soft start”.

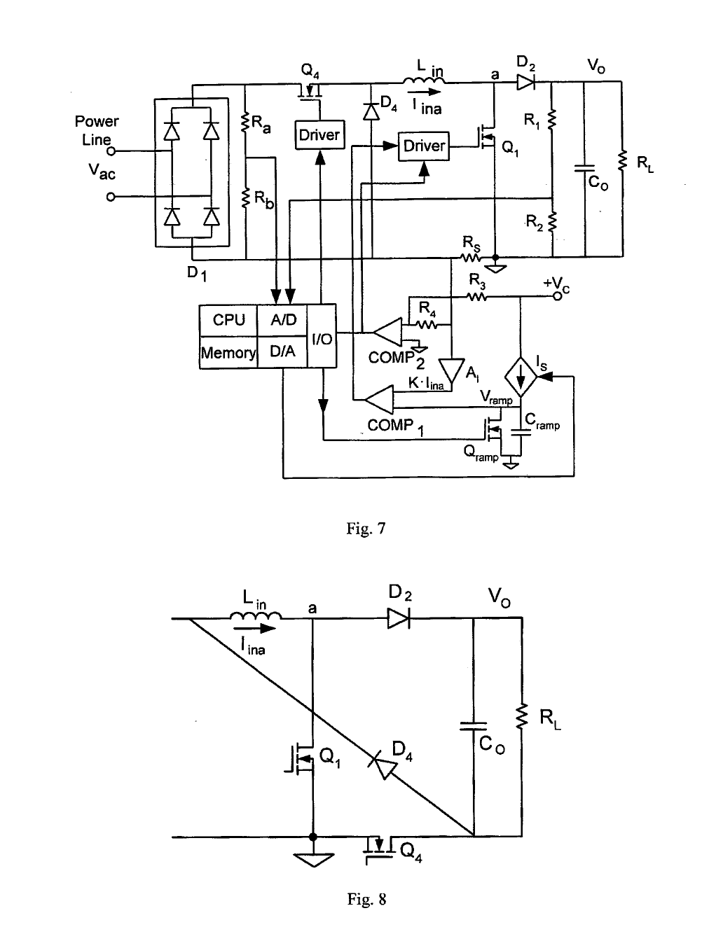

FIG. 7 illustrates schematically another embodiment of an APFC stage according to the present invention. Input current Iᵢₙₐ is sensed by sense resistor Rₛ and amplified by an amplifier A₁ operative to produce a signal K·Iᵢₙₐ.proportional to Iᵢₙₐ. A ramp generator including a controlled current source I_{S}, a capacitor Cᵣₐₘₚ, and a switch Qᵣₐₘₚ is operative to generate a triangular waveform Vᵣₐₘₚ that is compared to K·Iᵢₙₐ by a comparator COMP₁ operative to produce a signal having an off-duty-cycle D_{OFF} according to equation (6):

$${D}_{OFF} = \frac{{R}_{e}}{{V}_{o}} 〈 {I}_{ina} 〉$$

A digital controller 10 is operative to adjust coefficient Rₑ/Vₒ so as to match input current Iᵢₙₐ to load power. This is accomplished by comparing a measurement of output voltage Vₒ to a desired value for output voltage Vₒ and adjusting I_{S} to change the rate at which Vᵣₐₘₚ increases during the charging of Cᵣₐₘₚ. For example, if the measured value of Vₒ is less than the desired value of Vₒ, as would be the case after a decrease in load resistance R_{L}, digital controller 10 increases I_{S}, causing comparator COMP₁ to turn on earlier in the Vᵣₐₘₚ cycle, in turn increasing Iᵢₙₐ and causing Vₒ to increase toward the desired value for Vₒ. On the other hand, if the measured value of Vₒ is greater than the desired value for Vₒ, as would be the case after an increase in load resistance R_{L}, digital controller 10 decreases I_{S}, causing comparator COMP₁ to turn on later in the Vᵣₐₘₚ cycle, in turn decreasing Iᵢₙₐ and causing Vₒ to decrease toward the desired value for Vₒ. These changes in Iᵢₙₐ change the equivalent resistance Rₑ seen by the power line, and thus adjust coefficient Rₑ/Vₒ until output voltage Vₒ equals the desired target value for Vₒ. As discussed above, this correction need not be fast, so a low sampling rate will suffice. As an example, not to taken as limiting the present invention, a system according to the present invention operating with a power line frequency of 50 Hz can have a bandwidth of 10 Hz in the voltage-control loopand hence a sampling rate of let then 1000 samples per second will suffice. It will be readily apparent to those skilled in the art that adjustment of I_{S} by digital controller 10 as described above will compensate for changes in component values in the system, as may occur with aging or temperature changes, other than changes in the voltage-sensing circuitry, and for changes in such parameters as input voltage V_{ac} and output resistance R_{L}.

Inrush current limiting and protection against a short circuit at the output is provided by a series switch, Q₄, that is controlled in PWM mode by controller 10 so as to limit the inrush current and to disconnect the circuit when an overcurrent is detected by comparator COMP2. The output of COMP2 also disables the drive to main switch Q₁ for quick protection. Diode D₄ is operative to provide a current path for current flowing through inductor Lᵢₙ when switch Q₄ is in a non-conductive state. Other possible arrangements for providing inrush current limiting protection are depicted in FIGS. 8, 9 and 10.

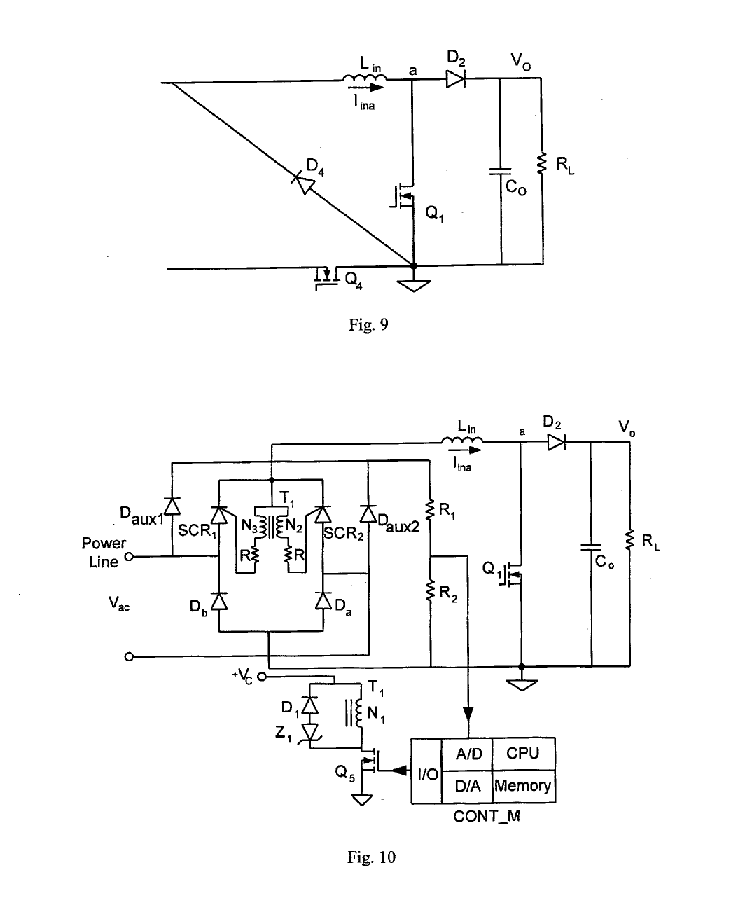

In FIGS. 8 and 9 series transistor Q₄ is placed in the ground branches. This lowers the common-mode noise injection. The advantage of the arrangement of FIG. 8 is the common ground for both Q₁ and Q₄, eliminating the need for gate drive isolation for Q₄. The advantage of the connection of FIG. 9 is that it does not break the connection between the ground of Q₁ and the ground of load R_{L}.

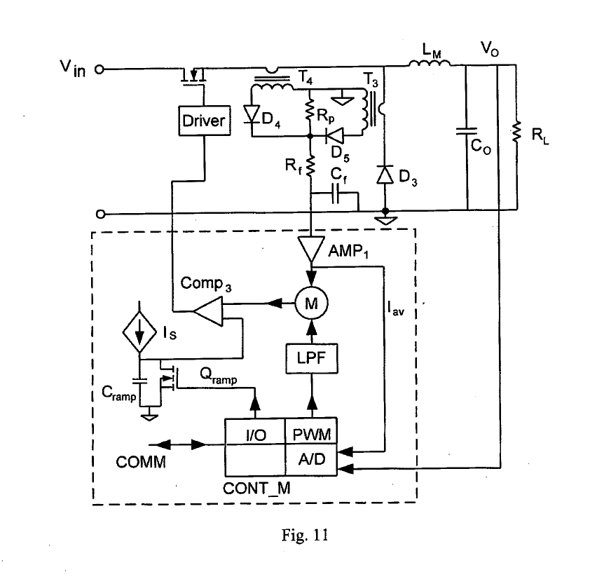

In the connection of FIG. 10, the inrush current is controlled by thyristors SCR₁ and SCR₂. The control signal is generated by the digital portion of mixed-mode controller CONT_M and fed to a pulse transformer T₁ via a transistor Q₅. Input voltage sensing is facilitated by auxiliary diodes Dₐᵤₓ₁ and Dₐᵤₓ₂.

Implementation of the present invention in a DC-DC converter is shown in FIG. 11. In this example the power stage is of the “buck” topology, and includes a power switch Q₄, an inductor L_{M}, a diode D₃ and an output filter capacitor Cₒ to which a load R_{L} is connected. Pulse transformers T₃ and T₄ are used to monitor current through inductor L_{M}, generating a voltage across a sense resistor Rₚ. Resistor R_{f} and capacitor C_{f} filter out the high-frequency components and amplifier AMP1 amplifies this voltage to a level that is compatible with the input signal range of a multiplier M. This signal, which is proportional to the average current through inductor L_{M}, is multiplied by an error signal generated by the digital portion of mixed-mode controller CONT_M to correct changes in output voltage Vₒ. The output signal of multiplier M is fed to a comparator COMP3 that generates the PWM signal. This is accomplished by comparing the output of multiplier M to a triangular wave generated by a current source I_{S} that feeds a ramp capacitor Cᵣₐₘₚ which is discharged by transistor Qᵣₐₘₚ at the desired switching frequency. The digital portion of mixed-mode controller CONT_M includes, in this embodiment, a logic core, such as a programmable microprocessor or logic array and digital input/output ports. Mixed-mode controller CONT_M also includes an A/D section and a capture and compare port, and is operative to generate a PWM signal. The error signal, which is a function of the deviation of output voltage Vₒ from a desired value, is converted to a PWM signal which is then filtered by low pass filter LPF to form an analog signal that is fed to multiplier M. In the controller scheme of FIG. 11, amplifier AMP1, multiplier M and the PWM modulator built around comparator COMP₃, provide the wide bandwidth required for the inner, current-control loop so that the converter can quickly respond to fast current changes. Overall voltage stabilization, which, as mentioned above, requires a lower bandwidth, is controlled by the digital portion of the controller. By sampling the amplified signal that represents the average current, Iₐᵥ, through inductor L_{M}, controller CONT_M can detect a persistent overcurrent situation and adjust the PWM signal accordingly. Controller CONT_M can also, optionally, send information about the loading level to a supervisory device, such as a computer (not shown) via a communication link COMM.

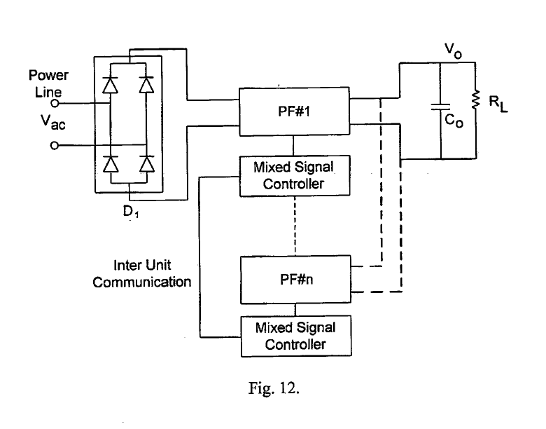

Another embodiment of the present invention is a multiple converter system as illustrated schematically in FIG. 12. This figure shows n converters PF#1 . . . PF#n that are powered from the line and connected in parallel to feed a single load R_{L}. Inter-unit communication, facilitated by the present invention, allows for current sharing between units PF#1 . . . PF#n so as not to overload any one of the units PF#1 . . . PF#n and to evenly distribute power losses.

While the invention has been described with respect to a limited number of embodiments, it will be appreciated that many variations, modifications and other applications of the invention may be made.

What is claimed is:

1. An active power factor correction power converter system comprising:
an analog control circuitry to control an input current of said system;
a digital control circuitry to control an output voltage of said system;
a current sampling device in the path of said input current to indicate an instantaneous value proportional to said input current being an input current indication
wherein said digital control circuitry is adapted to produce an analog signal responsive to variations in said output voltage, and
wherein said analog control circuitry is responsive to said analog signal.

2. The system of claim 1 wherein said current sampling device is placed in the ground path of said input current.

3. The system of claim 2 wherein said analog control circuitry further comprises:
a comparator unit responsive to an average of said input current indication and to a ramp-type signal generate by a controllable current source; and
a current controlling shunt switch to control the current drawn from a power source of said system,
wherein said current controlling shunt switch is switchable on or off responsive to a signal from said comparator.

4. The system of claim 1 wherein said digital control circuitry comprises a first voltage sampling branch to indicate an instantaneous value of said output voltage being an output voltage indication.

5. The system of claim 4 wherein said digital control circuitry further comprising a digital controller comprising a logic unit, a digitally controlled analog output, an analog-to-digital converter and an input/output unit.

6. The system of claim 5 wherein said digital controller further comprises a data storage unit.

7. The system of claim 4 wherein said digital control circuitry further comprises a second voltage sampling branch to indicate an instantaneous value of a rectified input voltage of said system being an input voltage indication

8. The system of claim 3 further comprising:
a controllable switching device connected in series in the path of said input current to limit said input current.

9. The system of claim 8 wherein said controllable switching device is controllable by a signal from said digital controller.

10. The system of claim 9 wherein said controllable switching device is connected in the ground path of said input current.

11. The system of claim 10 wherein said current controllable shunt switch and said controllable switching device are connected to have a common grounding node.

12. A method of controlling an input current and an output voltage in an active power factor correction power converter system comprising:
controlling an input current of said system by an analog control circuitry;
controlling an output voltage of said system by a digital control circuitry;
wherein said digital control circuitry is adapted to produce an analog signal responsive to variations in said output voltage, and
wherein said analog control circuitry is responsive to said analog signal.

13. The method of claim 12 further comprising
receiving a signal proportional to said input current being an input current indication.

14. The method of claim 13 further comprising:
comparing an average of said input current indication to a ramp-type signal; and
switching a current controlling shunt switch on or off in response to the result of said comparing step.

15. The method of claim 12 further comprising:
receiving a signal proportional to an instantaneous value of said output voltage.

16. The method of 15 further comprising:
receiving a signal proportional to an instantaneous value proportional to a rectified input voltage of said system.

17. The method of claim 14 further comprising:
controlling a maximum value of said input current by a controllable switching device in response to a signal from said digital control circuitry.

18. The method of claim 17 further comprising:
connecting said controllable switching device in series with the ground path of said input current.

19. An active power factor correction power converter system comprising:
an analog control circuitry to control an input current of said system;
a digital control circuitry to control an output voltage of said system;
a current sampling device in the ground path of said input current to indicate an average of an instantaneous value proportional to said input current being an input current indication;
a first voltage sampling branch to indicate an instantaneous value of said output voltage being an output voltage indication;
a comparator unit responsive to a signal proportional to said input current indication and to a ramp-type signal driven by a controllable current source;
a controllable current source to control the rise rate of said ramp-type signal to responsive to said output voltage indication; and
a second voltage sampling branch to indicate an instantaneous value of a rectified input voltage of said system being an input voltage indication,
wherein said digital control circuitry is adapted to produce an analog signal responsive to variations in said output voltage,
wherein said analog control circuitry is responsive to said analog signal
wherein said digital control circuitry further comprises a digital controller comprising logic unit, a digitally controlled analog output, an analog-to-digital converter and an input/output unit.

20. A method of controlling an input current and an output voltage in an active power factor correction power converter system comprising:
controlling an input current of said system by an analog control circuitry;
controlling an output voltage of said system by a digital control circuitry, said digital control circuitry is adapted to produce an analog signal responsive to variations in said output voltage,
receiving a signal proportional to an average of said input current being an input current indication;
receiving a signal proportional to an instantaneous value of said output voltage being an output voltage indication
comparing said signal proportional to said input current indication to a ramp-type signal;
switching a current controllable shunt switch on whenever said signal proportional to said input current indication is bigger than said ramp-type signal and off when it is smaller than said ramp-type signal;
controlling a rise rate of said ramp-type signal responsive to a deviation of said output voltage indication from a predetermined value; and
controlling a maximum value of said input current by a controllable switching device in response to a signal from said digital control circuitry.

21. A power converter system comprising:
a rectifying circuitry to rectify an AC power to DC power;
an analog control circuitry to control a current drawn from said rectifying circuitry;
a digital control circuitry to control an output voltage of said system;
a current sampling device in the ground path of said input current to indicate an average of an instantaneous value proportional to said input current being an input current indication;
a first voltage sampling branch to indicate an instantaneous value of said output voltage being an output voltage indication;
a comparator unit responsive to a signal proportional to said input current indication and to a ramp-type signal driven by a controllable current source;
a controllable current source to control the rise rate of said ramp-type signal to responsive to said output voltage indication; and
a second voltage sampling branch to indicate an instantaneous value of a rectified input voltage of said system being an input voltage indication,
wherein said digital control circuitry is adapted to produce an analog signal responsive to variations in said output voltage,
wherein said analog control circuitry is responsive to said analog signal, and
wherein said digital control circuitry further comprises a digital controller comprising logic unit, a digitally controlled analog output, an analog-to-digital converter and an input/output unit.
